(19) United States
(12) Patent Application Publication
(10) Pub. No.: US 2007/0020041 A1
(43) Pub. Date: Jan. 25, 2007

(54) Continuously blockable adjustment device

(75) Inventors: Peter Kohns, Vallendar (DE); Rolf Mintgen, Thuer (DE); Mario Schwab, Koblenz (DE); Wilhelm Schwab, Neuwied Koblenz (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH

(21) Appl. No.: 11/479,250

(22) Filed: Jun. 30, 2006

(30) Foreign Application Priority Data
Jul. 5, 2005 (DE) 10 2005 031 671.9

(51) Int. Cl. F16B 7/10

(52) U.S. Cl. 403/109.1

(57) ABSTRACT

A continuously blockable adjustment device for fixing two structural elements moveable in relation to one another, in particular a body of the motor vehicle and a door or flap of the motor vehicle moveable in relation to the body of the motor vehicle, includes a piston/cylinder unit with a cylinder, a piston displaceable axially in the cylinder, and a piston rod led out of the cylinder. The piston/cylinder unit has a piston-rod-side attachment element for connection to a first of the structural elements and a cylinder-side attachment element for connection to the second of the structural elements. A bracket at least partially engaging over the piston/cylinder unit axially is provided. The bracket 12 is fastenable in a first bracket end region to one of the two structural elements and, in a second bracket end region facing away from the first bracket end region, is tied to the piston-rod-side attachment element or the cylinder-side attachment element of the piston/cylinder unit.

### BACKGROUND OF THE INVENTION

1. Field of the Invention

The present invention relates to a continuously blockable adjustment device for fixing two structural elements moveable in relation to one another, in particular a door or flap of a motor vehicle moveable in relation to a body of the motor vehicle, having a piston/cylinder unit with a cylinder a piston displaceable axially in the cylinder and a piston rod led out of the cylinder, the piston/cylinder unit having a piston-rod-side attachment element for connection to a first of the structural elements and a cylinder-side attachment element for connection to the second of the structural elements.

2. Description of the Related Art

An adjustment device of this type is known, for example, as an actuating device for a door of a motor vehicle. The actuating device is articulated pivotally moveably on a door pillar of the body of the motor vehicle and comprises a piston/cylinder unit arranged between the door pillar and the door. The door is mounted on the door pillar with the aid of a hinge, a piston rod of the piston/cylinder unit being connected to the hinge. The actuating device further comprises a blocking valve controlling the flow of a pressure medium in a piston of the piston/cylinder unit. The blocking valve is activated by actuating means via a door handle in such a way that the door can be blocked in at least one intermediate position. The actuating device is complicated to produce and leads to a high load on the door hinge. Furthermore, a hydropneumatic spring capable of being used as a continuously blockable actuating device and having a piston/cylinder unit is known. This actuating device can be used for setting a door of a motor vehicle in a desired opening position. To set the desired position, a shut-off valve is opened in the spring and the door is moved to the desired opening position. The shut-off valve is closed again when the desired setting position is reached to fix the door in the desired opening position. On the one hand, the actuating device is fastened pivotably on a bearing bolt connected to a body of the motor vehicle; on the other hand, a bearing bolt connected firmly to the door forms a pivot bearing for the actuating device. The door is mounted in the body by means of a door hinge. High forces caused by the actuating device may arise on the mounting of the door.

### SUMMARY OF THE INVENTION

An object of the present invention is to provide an adjustment device for fixing two structural elements moveable in relation to one another, which has reduced production costs and allows an improved force flux.

The object according to the present invention is met by an adjustment device for fixing two structural elements movable in relation to one another having a piston/cylinder unit with a piston-rod-side attachment element and a cylinder-side attachment element, and a bracket at least partially engaging over the piston/cylinder unit axially, the bracket having a first bracket end region connectable to one of the two structural elements and a second bracket end region facing away from the first bracket end region, the second bracket end region being tied to the piston-rod-side attachment element or the cylinder-side attachment element of the piston/cylinder unit.

According to one embodiment, the piston/cylinder unit, which is preferably a hydropneumatic spring, is supported by the bracket on one of the two structural elements moveable in relation to one another, in particular a door of a motor vehicle, so that a directed and uniformly distributed introduction of force into the structural element by the bracket occurs. A large-area support of the piston/cylinder unit is made possible in this way, with the result being that it is unnecessary to reinforce the abovementioned structural element, for example using additionally welded-in metal sheets. This affords not only an advantageous weight reduction, but also a lowering of the outlay in manufacturing terms. The piston/cylinder unit can be connected preferably directly to the other of the two structural elements moveable in relation to one another, preferably to the more rigid of the structural elements, in particular a body of the motor vehicle. In the event of a change in the dimensions, in particular a change in length, of the piston/cylinder unit, caused, for example, by the use of a larger cylinder, it is merely necessary to provide another bracket adapted to the changed dimensions. There is no need to carry out changes to the structural elements moveable in relation to one another. Conversely, even changes which may be necessary on the structural elements moveable in relation to one another can be compensated by an adaptation of the bracket, without complicated structural changes having to be made on the piston/cylinder unit. The bracket at least partially engages over the piston/cylinder unit, specifically axially, that is to say in a direction parallel to the mid-axis of the piston/cylinder unit. The bracket thus engages over the piston/cylinder unit in the longitudinal direction of the latter.

The bracket may, for example, have a bar-shaped construction consisting essentially of a U-profile or alternatively being generally in the form of any desired carrying profile. The bracket may also have some elasticity, for example for damping purposes. By contrast, particularly for uniform force distribution and an especially accurate force flux, a specific embodiment of the bracket has a rigid hollow body at least partially surrounding the piston/cylinder unit. The hollow body in this case surrounds the piston/cylinder unit over the circumference of the latter, in particular over the circumference of the cylinder of the piston/cylinder unit. The mid-axis of the piston/cylinder unit and the mid-axis of the hollow body preferably coincide.

The bracket advantageously additionally affords good protection, in particular, of the piston/cylinder unit against environmental influences, in particular against dust and moisture, if, according to another development of the invention, the hollow body is designed as a pot and the second bracket end region surrounds the bottom of the pot. The bracket is in this case attached to the corresponding attachment element of the piston/cylinder unit at the bottom of the pot.

According to a further embodiment, the hollow body has a cone widening from the second bracket end region towards the first bracket end region, with the result that the force flux from the piston/cylinder unit to the structural element to which the bracket can be fastened and also the supporting action of the bracket can be further improved.

The bracket may also be produced very cost-effectively in large quantities if, according to another advantageous development of the invention, the bracket consists of a plastic. The bracket preferably consists solely of the plastic, but it is basically also conceivable to provide partially, for example in one bracket end region, stiffening insert parts consisting, for example, of metal.

In a further embodiment, a connection device for a screw fastening of the bracket is provided in the first bracket end region, thus allowing a simple fastening of the bracket to that of the two structural elements which is provided for this purpose. The connection device may have in the simplest way a passage recess for receiving a screw.

A change in the angular position of the adjustment device in the event of a pivoting of the structural elements moveable in relation to one another may be compensated simply and in an operationally reliable way if, according to another embodiment of the present invention, the bracket-tying attachment element of the piston/cylinder unit has a spherical element which, moreover, may serve for tolerance compensation. In this case, an oversize in the diameter of the spherical element ensures a freedom from play of the spherical element in a mounting of the spherical element over the entire lifetime of the adjustment device.

An especially reliable mounting can be achieved in that a recess in the form of a spherical cap, supporting the spherical element, is provided in the second bracket end region.

According to a further embodiment, the second bracket end region is connected to a cover covering the spherical element, with the result that the adjustment device and, in particular, the spherical element is additionally be protected against undesirable environmental influences, such as, for example, soiling. The cover may, for example, be screwed onto the second bracket end region or be fastened to the latter by separate screws or a ring-type snap connection. As a further alternative, the cover may, for example, be welded to the second bracket end region by an ultrasonic or laser weld.

A further-improved mounting of the spherical element may be achieved in that the cover has a recess in the form of a spherical cap, supporting the spherical element. The spherical element is mounted, preferably free of play, with the aid of the cover.

According to another embodiment of the invention, a simple and nevertheless reliable arrangement of the spherical element is achieved in that the attachment element tying the bracket has an axially oriented threaded bolt, and in that the spherical element is screwed to the threaded bolt. The threaded bolt is preferably welded to the cylinder of the piston/cylinder unit.

An especially accurate mounting of the spherical element is achieved according to a further embodiment in that the attachment element tying the bracket has a joint socket, and in that the spherical element is arranged in the joint socket.

The mounting of the spherical element is in this case further improved if the joint socket has a bearing bush for mounting the spherical element.

The assembly of the adjustment device is additionally simplified if the spherical element is fastened in the joint socket by a clip component. The clip component and the bearing bush can be connected to one another so as to form a single component.

A permanently accurate force flux and a construction of the adjustment device which has high operating reliability are achieved in that the threaded bolt or the joint socket passes centrally through the second bracket end region. For example, during the production of the adjustment device, the piston/cylinder unit is pushed into the bracket, the threaded bolt or the joint socket passing through the second bracket end region. When the end position of the piston/cylinder unit in the bracket is reached, the spherical element can be screwed onto the threaded bolt or can be inserted into the joint socket. After the spherical element has been screwed on or inserted, the piston/cylinder unit can be drawn into a spherical seat and the bracket can be closed by the cover.

The adjustment device has especially high functionality if the first bracket end region can be fastened to one end face of a door of a motor vehicle, the second bracket end region is tied to the cylinder-side attachment element of the piston/cylinder unit, and the piston-rod-side attachment element of the piston/cylinder unit can be connected to the body of the motor vehicle, the piston rod passing through the end face of the door. If the door is mounted on the body with the aid of two hinges, the adjustment device can be arranged preferably centrally between the hinges for a uniform force flux. The adjustment device can preferably be arranged in the door approximately in the longitudinal direction of the motor vehicle. Advantageously, for torque transmission, the piston-rod-side attachment element of the piston/cylinder unit can be connected to the body, and supported on the latter, at a distance from a hinge axis of the door about which the door is pivotable with respect to the body.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawing, wherein like reference characters denote similar elements throughout the several views:

FIG. 1 is a sectional perspective view of a first embodiment of an adjustment device according to the present invention;

FIG. 2 is a sectional side view showing the adjustment device of FIG. 1;

FIG. 3 is a sectional side view showing a detail of the adjustment device according to FIGS. 1 and 2;

FIG. 4 is a sectional perspective view of a second embodiment of an adjustment device according to the present invention;

FIG. 5 is a sectional side view showing the adjustment device of FIG. 4;

FIG. 6 is a sectional side view showing a detail of the adjustment device according to FIGS. 4 and 5;

FIG. 7 is a sectional side view of a further embodiment of an adjustment device according to the present invention; and

FIG. 8 is a sectional side view showing a detail of the adjustment device of FIG. 7.

### DETAILED DESCRIPTION OF THE PRESENTLY PREFERRED EMBODIMENTS

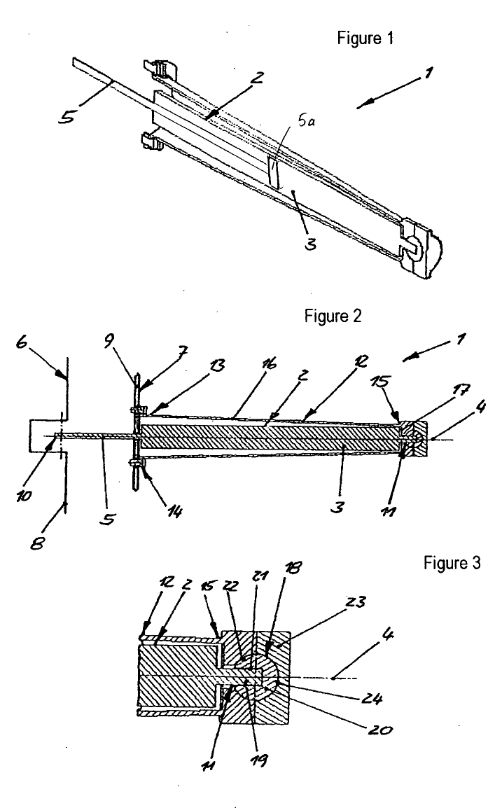

FIG. 1 shows a continuously blockable adjustment device 1 with a piston/cylinder unit 2 which possesses a cylinder 3 and a piston 5a displaceable in the cylinder 3 axially, that is to say in the direction of the mid-axis 4 (see FIG. 2) of the piston/cylinder unit 2, and having a piston rod 5 led out of the cylinder 3. The adjustment device 1 serves for fixing two structural elements 6, 7 moveable in relation to one another, which are illustrated in FIG. 2. In the present exemplary embodiment, a first structural element 6 of the structural elements 6, 7 moveable in relation to one another is a motor vehicle body 8, shown here only in part, and the second structural element 7 is a motor vehicle door 9, likewise shown only in part. The door 9 is pivotable with respect to the body 8 about a pivot axis, not illustrated.

The piston/cylinder unit 2 has a piston-rod-side attachment element 10 for connection to the body 8 and a cylinder-side attachment element 11 for connection to the door 9. Furthermore, a bracket 12 partially engaging axially over the piston/cylinder unit 2 is provided. The bracket 12 is fastened to the door 9 in a first bracket end region 13 by means of a screw connection 14. In a second bracket end region 15 facing away from the first bracket end region, the bracket 12 is tied to the cylinder-side attachment element 11 of the piston/cylinder unit 2. The bracket 12 thus connects the cylinder-side attachment element 11 to the second structural element 7 of the structural elements 6, 7 moveable in relation to one another.

The bracket 12, which is produced in one piece and consists of a plastic, has a rigid hollow body 16 surrounding the piston/cylinder unit 2 completely over the circumference of the latter. The hollow body 16, which has a cone widening from the second bracket end region 15 towards the first bracket end region 13, is designed as a pot, the second bracket end region 15 surrounding the bottom 17 of the pot. The closed hollow body 16 ensures a safe and reliable separation of moist space and dry space in the door 9, so that the interior of the door 9 is protected against the penetration of moisture and dirt.

Particularly in the enlarged illustration of FIG. 3, it can be seen that the attachment element 11 of the piston/cylinder unit 2, this attachment element tying the bracket 12 and being the cylinder-side attachment element 11 in this example, has a spherical element 18. Furthermore, that attachment element 11 of the piston/cylinder unit 2 which ties the bracket 12 has a threaded bolt 19 oriented axially and therefore in the direction of the mid-axis 4 of the piston/cylinder unit 2, the spherical element 18, which is designed here as a ball 20 with a blind-hole-shaped recess 21 having an internal thread, being screwed to the threaded bolt 19.

A recess 22 in the form of a spherical cap, supporting the spherical element 18, is provided in the second bracket end region 15. Moreover, the second bracket end region 15 is connected to a cover 23 which covers the spherical element 18 and which has a recess 24 in the form of a spherical cap, supporting the spherical element 18.

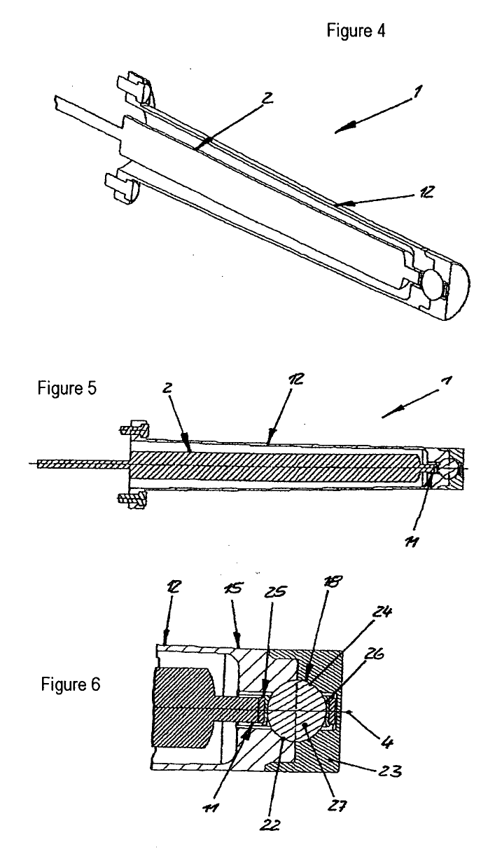

An adjustment device 1, similar to the adjustment device 1 illustrated in FIGS. 1 to 3, having a piston/cylinder unit 2 and a bracket 12 is shown in FIGS. 4 to 6 in views corresponding to FIGS. 1 to 3. In contrast to the first exemplary embodiment, a cylinder-side attachment element 11 of the piston/cylinder unit 2, which attachment element 11 ties the bracket 12 to the piston/cylinder unit 2, has a joint socket 25 in the exemplary embodiment according to FIGS. 4 to 6.

A spherical element 18 is arranged in the joint socket 25. For mounting the spherical element 18, the joint socket 25 is provided with a bearing bush 26 designed as a clip component. The bearing bush 26 is clipped into the joint socket 25 and holds the spherical element 18. Furthermore, the spherical element 18, which is designed as a solid ball 27, is mounted in a recess 22, in the form of a spherical cap, of a bracket end region 15 and in a recess 24, in the form of a spherical cap, of a cover 23 mounted on the abovementioned bracket end region 15.

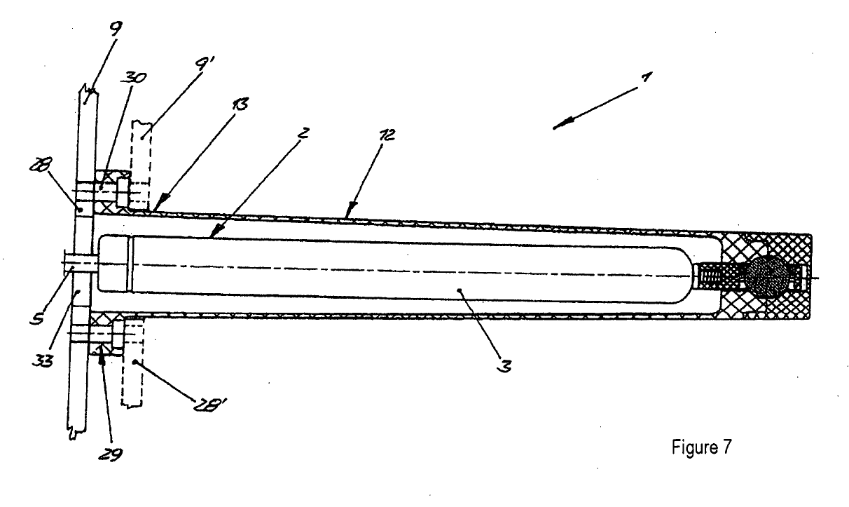

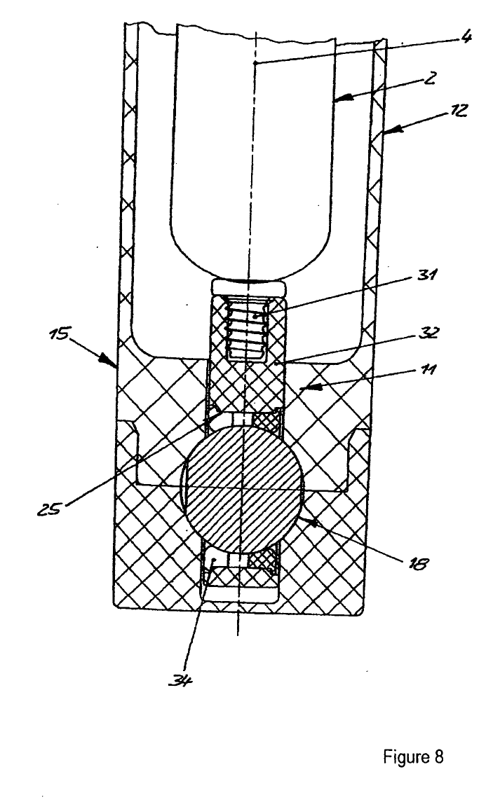

A similar adjustment device 1 with a piston/cylinder unit 2 having a cylinder 3 and a piston rod 5 is illustrated in FIGS. 7 and 8. In FIG. 7, an unbroken line illustrates part of an end face 28 of a door 9 of a motor vehicle to which a bracket 12 can be fastened, preferably screwed, in a first bracket end region 13 from the inside of the door 9. For this purpose, a connection device 29 with passage recesses 30 for the reception of screws is provided in the first bracket end region 13. The bracket 12 is fixed in the door 9 with the aid of two screws which, during assembly, are inserted into the passage recesses 30 of the bracket 12 and are secured against falling out by means of a snap connection or by means of a bottleneck on the respective cylinder part of the screws and against twisting by means of a positive fit. The piston rod 5 passes through the end face 28 of the door 9 through a recess 33 arranged in the end face 28. During an abovementioned mounting of the bracket 12 from inside, the maximum load in the tensile direction is absorbed by the bracket 12 and is transferred to the door 9; connection elements, here, in particular, screws, between the bracket 12 and the door 9 are subjected to minimal load.

As an alternative possibility for mounting the bracket 12 on a door 9′ of a motor vehicle, a dashed line illustrates part of an end face 28′ of the door 9′ of the motor vehicle, the bracket 12 being attached to the end face 28′ from outside. In such an embodiment in which the bracket 12 is inserted into the door 9′ from outside, maximum load in the tensile direction occurs on connection elements, in particular screws, between the bracket 12 and the door 9′.

FIG. 8 reveals that a cylinder-side attachment element 11 of the piston/cylinder unit 2 has a threaded bolt 31 mounted, preferably welded, on the cylinder 3 on the end face. An attachment piece 32 having a joint socket 25 is screwed onto the threaded bolt 31. A spherical element 18 for tying the bracket 12 to the piston/cylinder unit 2 is arranged in the joint socket 25, bearing shells 34 inserted into the joint socket 25 holding the spherical element 18. During a movement of the door, that is to say during an opening or closing of the door, the piston/cylinder unit 2 executes a slight pivoting movement which is made possible by the spherical element 18. Both the threaded bolt 19 in the exemplary embodiment according to FIGS. 1 to 3 and the respective joint socket 25 in the exemplary embodiments according to FIGS. 4 to 8 pass through the respectively corresponding bracket end region 15 centrally, that is to say in the direction of the mid-axis 4 of the piston/cylinder unit 2.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claims is:

1. A continuously blockable adjustment device for fixing two structural elements moveable in relation to one another, the two structural elements comprising a body of the motor vehicle and a door or flap of a motor vehicle moveable in relation to the body of the motor vehicle, said adjustment device comprising:
a piston/cylinder unit having a cylinder, a piston displaceable axially in the cylinder and a piston rod led out of the cylinder, the piston/cylinder unit having a piston-rod-side attachment element for connection to a first of the two structural elements and a cylinder-side attachment element for connection to the second of the two structural elements; and
a bracket at least partially engaging over the piston/cylinder unit axially, the bracket having a first bracket end region arranged and dimensioned to be connectable to one of the two structural elements and a second bracket end region facing away from the first bracket end region, the second bracket end region tied to one of the piston-rod-side attachment element or the cylinder-side attachment element of the piston/cylinder unit.

2. The adjustment device of claim 1, wherein the bracket comprises a rigid hollow body at least partially surrounding the piston/cylinder unit.

3. The adjustment device of claim 2, the hollow body is designed as a pot having an open top and closed bottom, wherein the second bracket end region is arranged at the bottom of the pot.

4. The adjustment device of claim 2, the hollow body (16) has a conical widening from the second bracket end region towards the first bracket end region.

5. The adjustment device of claim 1, wherein the bracket is plastic.

6. The adjustment device of claim 1, further comprising a connection device for a screw fastening of the bracket arranged in the first bracket end region.

7. The adjustment device of claim 1, further comprising an attachment element of the piston/cylinder unit which ties the bracket to the one of the piston-rod-side attachment element or the cylinder-side attachment element, the attachment element having a spherical element.

8. The adjustment device of claim 7, wherein the second bracket end region defines a recess in the form of a spherical cap supporting the spherical element.

9. The adjustment device of claim 8, further comprising a cover arranged on the second bracket end region and covering the spherical element.

10. The adjustment device of claim 9, wherein the cover has a recess in the form of a spherical cap supporting the spherical element.

11. The adjustment device of claim 7, wherein the attachment element includes an axially oriented threaded bolt threadably engaged with the spherical element.

12. The adjustment device of claim 7, wherein the attachment element has a joint socket, the spherical element being arranged in the joint socket.

13. The adjustment device of claim 12, wherein the joint socket has a bearing bush for mounting the spherical element.

14. The adjustment device of claim 12, further comprising a clip component fastening the spherical element in the joint socket.

15. The adjustment device of claim 11, wherein the threaded bolt passes centrally through the second bracket end region.

16. The adjustment device of claim 12, wherein the joint socket passes centrally through the second bracket end region.

17. The adjustment device of claim 1, wherein the first bracket end region is arranged and dimensioned to be fastened to an end face of a door of a motor vehicle, the second bracket end region is tied to the cylinder-side attachment element of the piston/cylinder unit, and the piston-rod-side attachment element of the piston/cylinder unit is arranged and dimensioned to be connected to the body of the motor vehicle, the piston rod passing through the end face of the door.
